(19) United States
(12) Patent Application Publication
(10) Pub. No.: US 2005/0172076 A1
(43) Pub. Date: Aug. 4, 2005

(54) System for managing distributed cache resources on a computing grid

(75) Inventors: Anthony Olson, Dakota Dunes, SD (US); Robert J. Burnett, Dakota Dunes, SD (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(73) Assignee: Gateway Inc.

(21) Appl. No.: 11/047,186

(22) Filed: Jan. 31, 2005

Related U.S. Application Data
(60) Provisional application No. 60/540,413, filed on Jan. 30, 2004.

(51) Int. Cl. G06F 12/00

(52) U.S. Cl. 711/122; 711/119; 711/133

(57) ABSTRACT

A method and system of managing a cache is disclosed which comprises receiving a request for a resource, determining if a copy of the resource is stored in the cache, and the cache includes at least a first level of cache and a second level of cache. The method further includes counting a number of times that the requested resource, having a copy stored in the cache, has been requested, and promoting the copy of the requested resource in the cache based upon a count of the number of times that the requested resource has been requested.

### REFERENCE TO RELATED APPLICATIONS

This application claims the benefit of U.S. Provisional Patent Application No. 60/540,413, which was filed on Jan. 30, 2004, and which is incorporated by reference herein in its entirety.

### BACKGROUND OF THE INVENTION

1. Field of the Invention

The present invention relates to grid computing systems and more particularly pertains to a system for managing distributed cache resources on a computing grid.

2. Description of the Prior Art

In certain system architectures or network architectures, caches are employed to keep information that is most likely to be needed as close as possible to the entity or entities that are more likely to request the information. In many cases, there are multiple layers in the memory hierarchy and multiple levels of cache. However, in certain situations the amount of memory and/or cache available at a given level might raise or fall based on the current operating conditions present at the time. Additionally, the bandwidth of information movement that is available between memory layers or cache levels may increase or decrease in a dynamic fashion based on the current operating conditions. The result is the most appropriate memory and cache architecture for a given system or network might vary over time, which can cause problems in cases where the architecture of those elements is fixed, or not readily adjustable to meet changing conditions.

### SUMMARY OF THE INVENTION

The invention contemplates a system and method for managing distributed cache resources on a computing grid dynamically configuring a cache hierarchy used by at least one constituent computer system to reduce time and resources required to retrieve information.

In one aspect of the invention, a method of managing a cache is disclosed which comprises receiving a request for a resource, determining if a copy of the resource is stored in the cache, and the cache includes at least a first level of cache and a second level of cache. The method further includes counting a number of times that the requested resource, having a copy stored in the cache, has been requested, and promoting the copy of the requested resource in the cache based upon a count of the number of times that the requested resource has been requested.

In another aspect of the invention, a system for managing a cache is disclosed, which includes means for receiving a request for a resource, means for determining if a copy of the resource is stored in the cache, with the cache including at least a first level of cache and a second level of cache. The system further includes means for counting a number of times that the requested resource, having a copy stored in the cache, has been requested, and means for promoting the copy of the requested resource in the cache based upon a count of the number of times that the requested resource has been requested.

### BRIEF DESCRIPTION OF THE DRAWINGS

FIG. 1 is a schematic diagram of a computing grid or network showing the various locations and associations of cache memory on the computing grid.

FIG. 2 is a schematic table of variables utilized in various aspects of the invention as contemplated. The variables defined in FIG. 2 are used through the schematic flow diagram of FIGS. 3 through 9.

FIG. 3 is a partial schematic flow diagram or map of the high level action of one implementation of a process used to dynamically configure the cache hierarchy.

FIG. 4 is a partial schematic flow diagram of one implementation of a process used to dynamically configure the cache hierarchy. FIG. 4 presents additional detail of block A in FIG. 3.

FIG. 5 is a partial schematic flow diagram of one implementation of a process used to dynamically configure the cache hierarchy. FIG. 5 presents additional detail of block B in FIG. 3.

FIG. 6 is a partial schematic flow diagram of one implementation of a process used to dynamically configure the cache hierarchy. FIG. 6 presents additional detail of block C in FIG. 3.

FIG. 7 is a partial schematic flow diagram of one implementation of a process used to dynamically configure the cache hierarchy. FIG. 7 presents additional detail of block D in FIG. 3.

FIG. 8 is a partial schematic flow diagram of one implementation of a process used to dynamically configure the cache hierarchy. FIG. 8 presents additional detail of block E in FIG. 3.

FIG. 9 is a partial schematic flow diagram of one implementation of a process used to dynamically configure the cache hierarchy. FIG. 9 presents additional detail of block F in FIG. 3.

FIG. 10A is a schematic diagram of multiple levels of cache memory in a network shown in a first state before the levels of cache have been adjusted dynamically to meet current cache operating conditions.

FIG. 10B is a schematic diagram of multiple levels of cache memory in a network in a second state after the levels of cache have been adjusted dynamically to meet current cache operating conditions.

FIG. 11 is a schematic representation of a cache for a user of the system of the invention with a breakdown of the various levels of cache present in the cache.

FIG. 12 is a schematic diagram of a grid system illustrative of one scenario of forced information flow with respect to storage resources on the cache system of the grid.

FIG. 13 is a schematic diagram of a grid system illustrative of another scenario of forced information flow with respect to storage resources on the cache system of the grid.

FIG. 14 is a schematic diagram of a grid system illustrative of another scenario of forced information flow with respect to storage resources on the cache system of the grid.

### DETAILED DESCRIPTION OF THE INVENTION

Aspects of the invention will now be described in greater detail in connection with a number of exemplary embodiments. To facilitate an understanding of the invention, some aspects of the invention may be described in terms of sequences of actions to be performed by elements of a computer system. It will be recognized that in each of the embodiments, the various actions could be performed by specialized circuits (e.g., discrete logic gates interconnected to perform a specialized function), by program instructions being executed by one or more processors, or by a combination of both.

Moreover, portions of the invention can additionally be considered to be embodied entirely within any form of computer readable storage medium having stored therein an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiment may be referred to herein as a “software algorithm configured to” perform a described action or alternatively as “software” that performs a described action, or other such terms.

The invention generally contemplates a system and method for managing cache and memory resources in a manner that is highly suitable for employment on a computing grid, utilizing cache or cache-like resources on constituent systems of the computing grid efficiently.

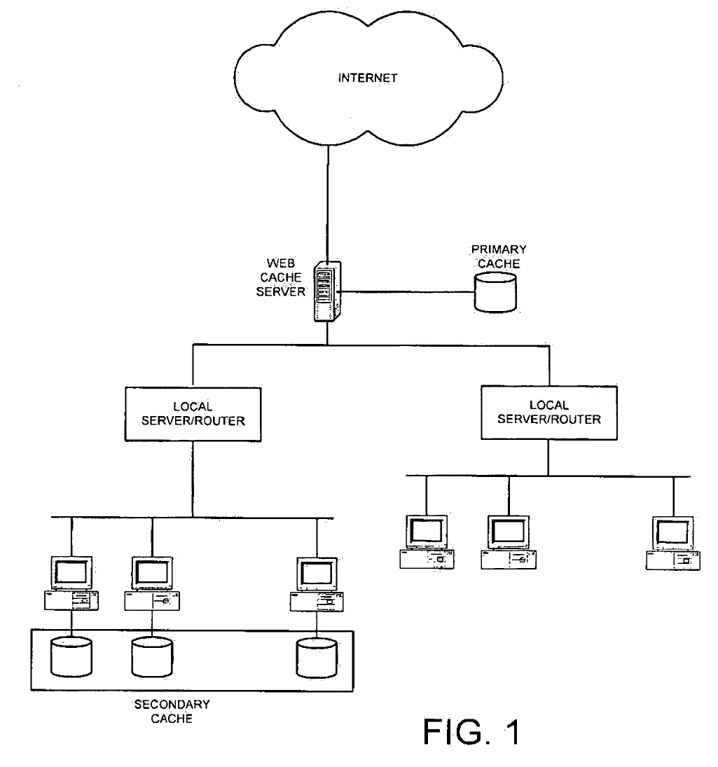

More particularly, as shown in FIG. 1 of the drawings, in an illustrative implementation of the invention, a network or subnetwork is shown which is in communication with a larger network, such as the Internet. The larger network may be highly distributed in nature with the subnetworks in communication with the larger Internet network forming a grid or computers or grid network. This grid network will typically include a similarly highly distributed network of resources, such as storage, that may act as a distributed cache for the larger grid network.

The illustrative network includes a server that is in communication with the Internet and the local network. While the server may perform a number of functions, it may also act to manage local storage resources, or cache, for the larger network, and it this function that will be the focus of this description. The web cache server may be provided with a primary cache resource. In some implementations of the invention, the primary cache may be utilized to hold data that is relatively frequently accessed, as compared to other cached data stored in cache resources on the local network, as the primary cache may be a dedicated network resource that is not also utilized for more localized storage.

In the illustrative local network, at least two local servers/routers are present and in communication with the web cache server. Each of the local servers may be associated with one or more networked devices, such as personal computers. Each of the networked personal computers will typically have storage that is a part of the computer, or is closely associated with the computer. This storage will in many cases comprise an internal (or external) hard disk drive that is usually installed on the computer, or may be connected to the computer as an external device. The hard disk drive is merely an example of one type of storage that may be associated with the computer, and other types and forms of storage may be utilized in a similar fashion as the hard disk drive. Many storage or memory devices have been devised to hold data, including devices that interface with the computer by means of a connection such as the Universal Serial Bus (USB) port, 1394 or Fire Wire port, and the like. It will be evident that more persistent, and less removable, types of storage are probably the most suitable for utilization by the invention, but other, less persistent or removable forms of storage may still be utilized.

Conceptually, the storage associated with each of the computers of the local networks connected to the grid network may be conceptually thought of, and administered as, a secondary level of cache for the grid network. The secondary level of cache may be suitable for providing short term and relatively fast access storage for the grid network, but access to this secondary level is not likely to be as fast to access as the storage associated with the primary level of cache. Thus the primary level of cache may be most suitable for a level one (L1) cache, and the secondary cache may be more suitable for a level 2 (L2) cache.

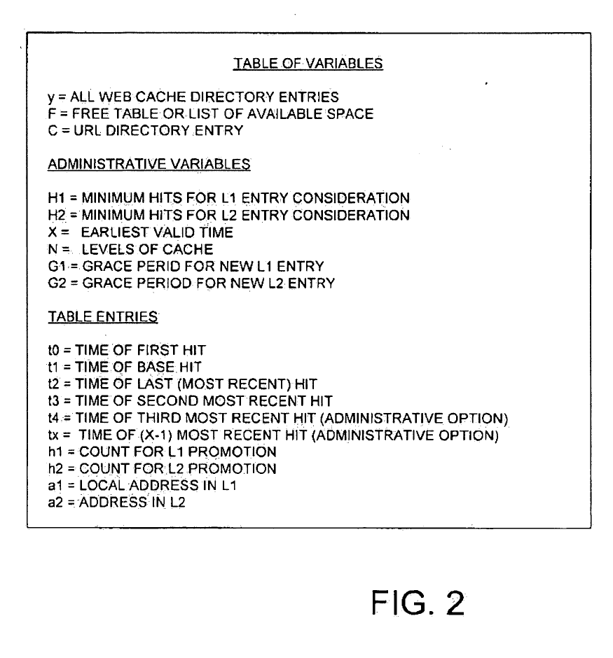

Before considering various aspects of the procedures for the operation and maintenance of the cache structure, various administrative aspects of the system will be described to provide a background for understanding the processes depicted in the drawings and described below. A number of variables and symbols are employed in the drawings, and a listing of these variables is provided in FIG. 2 with a short description of the element, which is expanded upon in the following description.

A number of elements or data structures may be implemented for managing the distributed cache resources and the algorithm employed to administer the cache resources. One administrative element is a web cache directory (WCD) that includes a table of the resources available on the cache structure of the grid network. These resources may be entered or designated on the WCD as the location of the resource on the larger (Internet) network, and the location designation may be in the form of the uniform resource locator (URL) of the particular resource on the larger network. The WCD may thus include entries (C) that identify the location, such as the URL, of various data items that are currently being stored in the cache structure of the system.

An additional administrative element (F) is a table or list of free or available locations of the cache structure that are available for receiving data items to be cached. These locations may be empty of data items, or available to be overwritten by new data items.

The administrative elements may optionally include a number of variables that may apply to more than one of the data items that are stored in the cache. The values for these variables may be set by an administrative entity or administrator according to the circumstances or conditions present on the local networks and the larger (such as the Internet) network. One variable (H1) is the minimum number of hits required for a data item to be considered for inclusion in the level one (L1) cache of the cache structure of the system. Another variable (H2) is the minimum number of hits required for a data item to be considered for inclusion in the level two (L2) cache of the cache structure. It will be realized that increasing the values assigned to these variables will decrease the relative size of the caches and decreasing the values assigned to these variables will increase the relative size of the caches. An additional variable (X) is the earliest valid time for consideration in determining what data items are included in the levels of the cache structure. It will be realized that the smaller the value that this variable has, the more recent the basis that is used for determining what data items are cached, while the larger that this value has, the more historic the basis for making this determination. Another variable (N) is the number of levels of cache that may be established in the cache structure of the system. The lower the value that is assigned to this variable, the relatively flatter the shape of the cache structure will be. Still other variables that may be assigned values include the grace time period for a new entry into the L1 cache (G1) and the grace time period for a new entry into the L2 cache.

Another administrative element that may be implemented and maintained is a table containing information about each of the units of data having entries in the WCD. The table may include a number of entries for each unit of data listed in the WCD, including the time of the first cache hit (t0) for the unit of data, the time of the base hit (t1) for the unit of data, the time of the last, or most recent, cache hit (t2) for the unit of data, and the time of the second-to-last, or second most recent, cache hit (t3) for the unit of data. Optionally, the table may also include entries for the third-to-last, or third most recent, cache hit (t4) for the unit of data, and may include as many levels of times as the administrator might desire, so that the table includes the time of the (x−1) most recent cache hit (tx) for the unit of data.

The table may also include an entry (h1) for the count or accumulated number of cache hits for the unit of data to be promoted to the L1 level of cache, and may also include an entry (h2) for the count or accumulated number of cache hits for a unit of data to be promoted to the L2 level of cache. The table may also include an entry for the local address (a1) of the unit of data in L1 cache, and may also include am entry for the local address (a2) of the unit of data in L2 cache.

In one preferred implementation of the invention, the WCD table or tables and the associated data may be maintained in the L2 or secondary level of the cache structure, although the tables and data could be stored in other levels of cache or other locations.

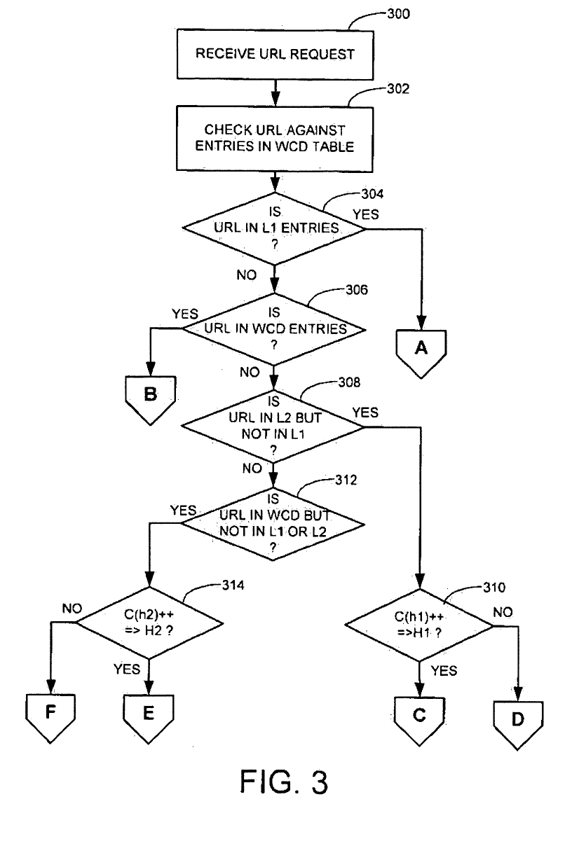

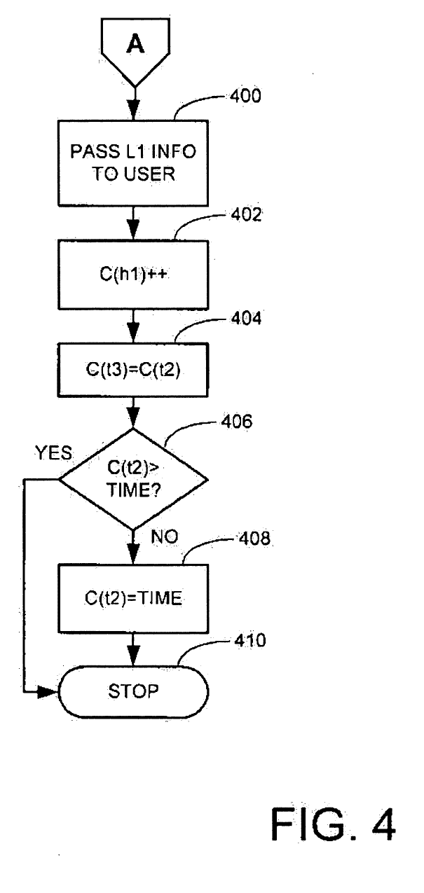

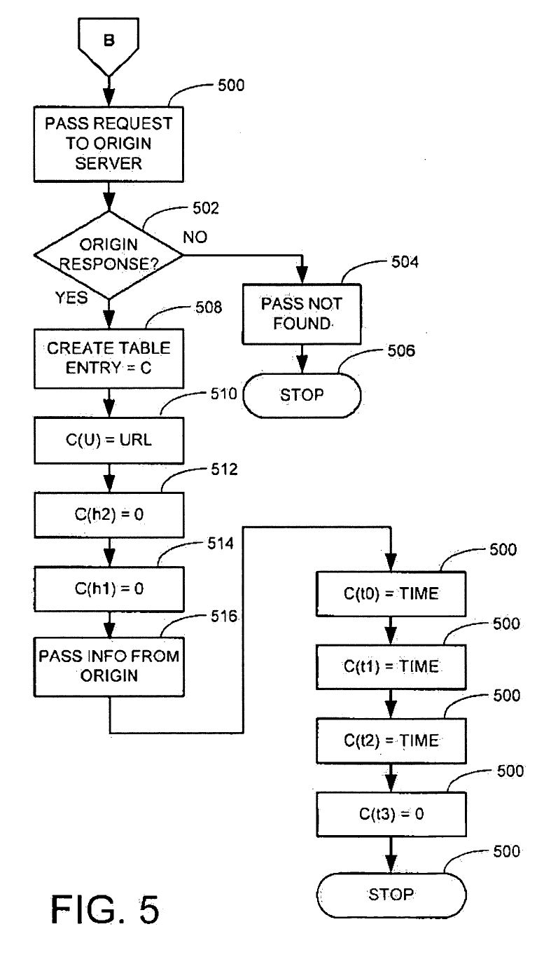

Turning to FIG. 3, which depicts a map of operation of the system of the invention at a relatively high level operation, a request is received by the system for a resource, and initially a determination is made whether the resource is being cached or stored on the grid network in the cache structure. In the illustrative implementation of the invention, the request for the resource is in the form of a universal resource locator (URL) that designates the location of the resource on the larger network (block 300). When received, the URL request is examined to determine if the resource is currently being held in the cache structure by checking the WCD (block 302). Initially, it is determined whether the resource associated with the URL is associated currently stored in the L1 level of the cache structure (block 304). If the resource underlying the URL is currently stored in the L1 cache, a process may be executed that is depicted in FIG. 4 and is discussed in greater detail below. If the underlying resource is not currently indicated as being stored in L1 cache, then a determination is made whether the resource associated with the URL has an entry in the WCD (block 306). If the requested resource does not have a current entry in the WCD, then a process may be executed that is depicted in FIG. 5 and is discussed in greater detail below. If, on the other hand, the requested resource does have an entry in the WCD (block 304), then the URL of the underlying resource is checked to determine if there is an entry for the resource in the L2 level of the cache structure (block 308).

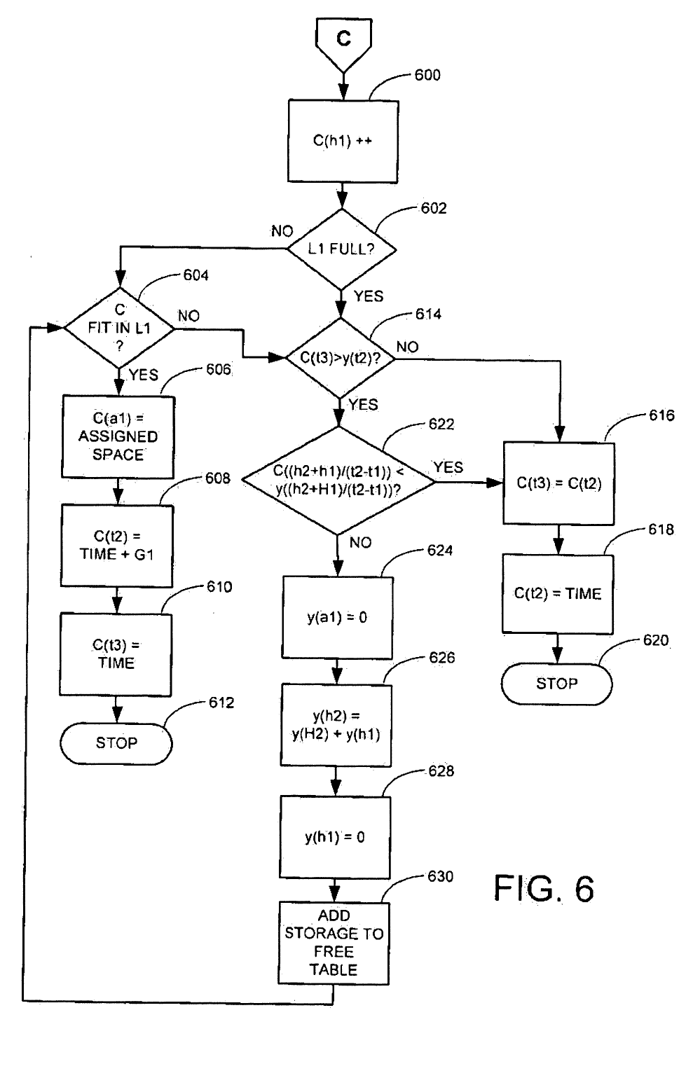

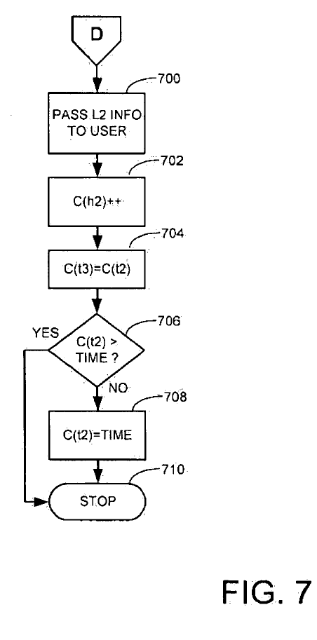

If the requested resource is determined to be in the L2 level of the cache structure, then the entry for the requested resource in the WCD is updated by incrementing the value assigned to the variable (h1) holding the count for promotion of the resource to the L1 level of the cache structure (block 310). The value for the h1 variable is compared to the value of the variable (H1) indicating the minimum number of cache hits necessary for consideration of promoting the resource to the L1 level of the cache structure. If the value of the h1 variable for this resource is equal to, or greater than, the value of the H1 variable for advancement to the L1 level of the cache structure, a process may be executed that is depicted in FIG. 6 and is discussed in greater detail below. In contrast, if the value of the h1 variable for this resource is less than the value of the H1 variable, a process may be executed that is depicted in FIG. 7 and is discussed in greater detail below.

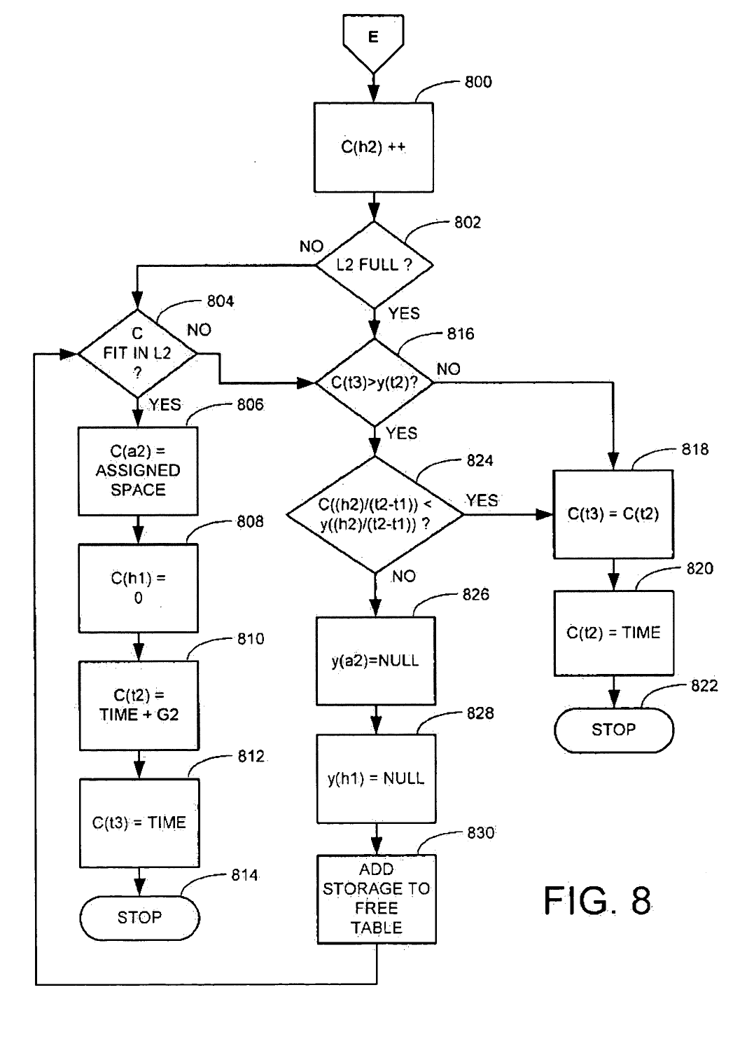

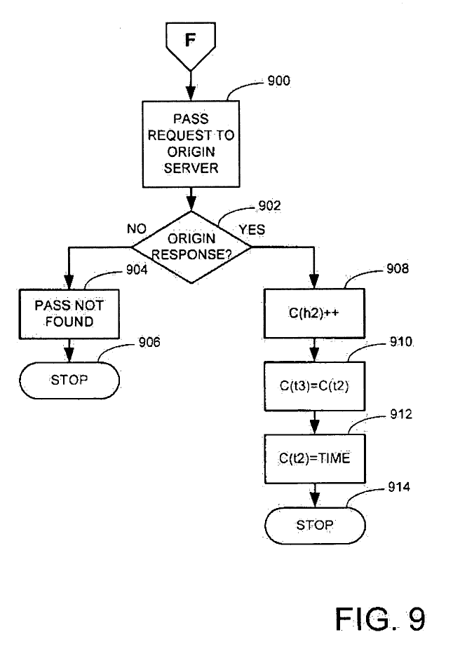

Returning to the determination of whether the resource has an entry for the resource in the L2 level of the cache structure on the WCD (block 308), if the there is no entry in the WCD table at the L2 level of cache, then a determination is made that (block 312), while the WCD does include an entry for the requested resource, the requested resource is not located in the L1 or L2 levels of the cache structure. The process then continues with the incrementing the value of the h2 variable, which is the count for promotion to the L2 level of the cache structure, and this newly incremented count is compared to the value of the variable (H2) which is the minimum number of hits required to promote the requested resource to the L@ level of the cache structure. If the value of the h2 variable for this resource is equal to, or greater than, the value of the H2 variable for advancement to the L2 level of the cache structure, a process may be executed that is depicted in FIG. 8 and is discussed in greater detail below. In contrast, if the value of the h2 variable for this resource is less than the value of the H2 variable, a process may be executed that is depicted in FIG. 9 and is discussed in greater detail below.

Considering FIG. 4, a process is depicted for handling resource requests for resources that have an entry in the WCD table and the entry in the WCD table indicates that the requested resource is stored in the L1 level of the cache structure. Initially, responsive to the resource request, the information associated with the requested resource is passed to the requestor or user from the cache structure (block 400). The value of the h1 variable, which stores the count for promotion to the L1 cache, is incremented (block 410). Even though the requested resource already resides in the L1 level of the cache structure, the h1 counter is incremented so that hits that are received after the resource has been promoted are not ignored, and to give an accurate indication of the relative activity for the cached resource. For the entry in the WCD table for the requested resource, the value of the variable t3, which is the time of the second most recent hit previous to the hit being considered) is set equal to the value of the variable t2, which is the time of the most recent hit prior to the hit being considered (block 406). If the value of the variable t2 is not greater than the present time (block 408), then the value of t2 is set equal to the present time (block 410) and the process is terminated (block 412). If the value of the variable t2 is greater than the present time (block 408), then the process is terminated (block 412) without adjustment to the value of the variable t2. The process is thus terminated until the next resource request is received, and the process depicted in FIG. 3 is reinitiated.

Turning now to FIG. 5, a process is depicted for handling resource requests for resources that do not currently have any entry in the WCD table. Initially, the resource request is passed to the server from which the requested resource originates (block 500), since the WCD does not indicate that the requested resource is currently being stored in the cache structure. The system may wait for a response from the originating server (block 502), and if there is no response from the originating server, it is concluded that the resource has not been found (block 504) and the process is terminated with no further change to the WCD or the cache structure (block 506). If a response is received from the originating server (block 502), then an entry is created in the WCD table for the requested resource (block 508). This entry, signified by “C” in the drawings, includes the URL of the requested resource (block 510) and the value of the h2 variable (the current count for promotion to the L2 level of cache) is set to an initial value, preferably zero (block 512). Similarly, the value of the h1 variable (the current count for promotion to the L1 level of cache) is also set to an initial value of zero for the entry corresponding to the requested resource (block 514). The information or data associated with the requested resource may then be passed from the originating server to the requester (block 516), and the entry associated with the requested resource in the WCD table is further update by setting the value of the t0 variable (the time of the first hit) equal to the current time (block 518). Similarly, the value of the variable t1 signifying the base hit for the requested resource is also set to the current time (block 520), and the value of the variable t2 signifying the last or most recent hit is also set to the current time (block 522). The value of the variable t3, which indicates the time of the second most recent hit for the resource, is set to zero (block 524). The process may then be terminated (block 526) until the next resource request is received, and the process depicted in FIG. 3 is reinitiated.

In FIG. 6, a process is depicted for handling resource requests for resources that are currently stored in the L2 level of the cache structure, and are eligible for promotion to level L1 of the cache structure. This situation occurs when, for example, the value of the h1 variable for this resource is determined to be equal to, or greater than, the value of the H1 variable at the most recent resource request (block 310).

Initially, the value of the h1 variable, which stores the count for promotion to the L1 level of cache, is incremented (block 600), and a check may be made as whether the L1 level of cache is full (block 602) or has additional storage that is not being used to store data for a resource. If it is determined that the L1 level of the cache structure is not full, then it is determined if the requested resource will fit in the unused portion of the L1 level of cache (block 604). If it is determined that there is sufficient room in the L1 level of cache to store a copy of the requested resource, then the copy of the requested resource is assigned an address space in the L1 level of cache and the address is recorded, such as under the variable a1 in the table of the WCD (block 606). The value of the variable (t2) indicating the time of the most recent hit for the requested resource is set equal to the present time plus the value of a grace time period (G1) for a new entry into the L1 level of the cache structure (block 608). The value of the variable (t3) indicating the time of the most recent hit for the requested resource is set equal to the present time (block 610). The process may then be terminated (block 612).

If it is determined that the L1 level of the cache structure is full (block 602), or if it is determined that the L1 level of cache is not full but does not have sufficient free space to accept a copy of the requested resource (block 604), then the process proceeds to a determination of whether the value of the time of the second most recent hit for the requested resource is greater than the value of the time of the most recent hit for all WCD cache entries (block 614). If the value is not greater, then the value of the variable (t3) reflecting the time of the second most recent hit for the requested resource is set equal to the value of the time of the most recent hit for the requested resource (block 616), the value for the time of the most recent hit is set equal to the present time (block 618), and the process is terminated (block 620). If the value is greater (block 614), then a determination is made whether the sum of the values of the counts for L2 promotion (h2) and L1 promotion (h1) divided by the difference in the values of the most recent hit and the time of the base hit for the requested resource (C(h2+h1)/(t2−t1)) is less than the sum of the values of the counts for L2 promotion (h2) and L1 promotion (h1) divided by the difference in the values of the most recent hit and the time of the base hit for all entries in the WCD (Y((h2+h1)/(t2−t1)) (block 622).

If this relationship is true, then the value of the variable (t3) reflecting the time of the second most recent hit for the requested resource is set equal to the value of the time of the most recent hit for the requested resource (block 616), the value for the time of the most recent hit is set equal to the present time (block 618), and the process is terminated (block 620). If the relationship is not true, then the local addresses in the L1 level of cache for all entries in the WCD is set to zero (block 624). The value of the most recent hit for all entries in the WCD is set equal to the sum of the previous value of the second most recent hit and the value of the most recent hit for all WCD entries (block 626), and the value for the count for promotion to the L1 level of the cache structure is set to zero for all entries in the WCD (block 628). The storage is added to the table of free storage on the cache structure (block 630), and then the process may proceed to a determination of whether the requested resource will fit in the L1 level of cache (block 604).

Considering now FIG. 7 of the drawings, where a process is depicted for handling resource requests for resources that are currently stored in the L2 level of the cache structure, and are not considered to be eligible for promotion to level L1 of the cache structure as of the current request for this resource. This situation occurs when, for example, the value of the h1 variable for this resource is less than the value of the H1 variable, at the most recent resource request (block 310). The requested resource is passed from the location in the L2 level of the cache structure to the requestor or user (block 700), and the value of the variable h2 which signifies the count for L2 promotion for the requested resource is incremented (block 702) in the WCD entry for the resource. The value of the time of the second most recent hit for the requested resource is set equal to the value of the time of the most recent hit (block 704). A comparison is then made between the value of the variable (t2) indicating the time of the most recent hit for the requested resource and the current time (block 706), and if the value of the most recent hit is greater than the current time, the process is terminated (block 710). If the value of the variable for the most recent hit for the requested resource is not greater than the current time, then value of the variable for the most recent hit is set equal to the current time (block 708) and the process is terminated (block 710).

Turning to FIG. 8, a process is depicted for handling resource requests for resources that have an entry in the WCD table but are not stored in the L1 or L2 levels of cache, and the resources are eligible for promotion to level L2 of the cache structure at this resource request. This situation occurs when, for example, the value of the h2 variable for this resource is equal to, or greater than, the value of the H2 variable at the time of the most recent request for the resource (block 314).

Initially, the value of the h2 variable, which stores the count for promotion to the L2 level of cache, is incremented (block 800), and a check may be made as whether the L2 level of cache is full (block 802) or has additional storage that is not being used to store data for a resource. If it is determined that the L2 level of the cache structure is not full, then it is determined if the requested resource will fit in the unused portion of the L2 level of cache (block 804). If it is determined that there is sufficient room in the L2 level of cache to store a copy of the requested resource, then the copy of the requested resource is assigned an address space in the L2 level of cache and the address is recorded, such as under the variable a2 in the table of the WCD (block 806). The value of the variable indicating the count for promoting the requested resource to L1 cache is set equal to zero for the requested resource (block 808). The value of the variable (t2) indicating the time of the most recent hit for the requested resource is set equal to the present time plus the value of a grace time period (G2) for a new entry into the L2 level of the cache structure (block 810). The value of the variable (t3) indicating the time of the most recent hit for the requested resource is set equal to the present time (block 6812). The process may then be terminated (block 814).

If it is determined that the L2 level of the cache structure is full (block 802), or if it is determined that the L2 level of cache is not full but does not have sufficient free space to accept a copy of the requested resource (block 804), then the process proceeds to a determination of whether the value of the time of the second most recent hit for the requested resource is greater than the value of the time of the most recent hit for all WCD cache entries (block 816). If the value is not greater, then the value of the variable (t3) reflecting the time of the second most recent hit for the requested resource is set equal to the value of the time of the most recent hit for the requested resource (block 818), the value for the time of the most recent hit is set equal to the present time (block 820), and the process is terminated (block 822). If the value is greater (block 816), then a determination is made whether the value of the count for L2 promotion (h2) divided by the difference in the values of the most recent hit and the time of the base hit for the requested resource (C(h2)/(t2−t1)) is less than the value of the count for L2 promotion (h2) divided by the difference in the values of the most recent hit and the time of the base hit for all entries in the WCD (Y((h2)/(t2−t1)) (block 824).

If this relationship is true, then the value of the variable (t3) reflecting the time of the second most recent hit for the requested resource is set equal to the value of the time of the most recent hit for the requested resource (block 818), the value for the time of the most recent hit is set equal to the present time (block 820), and the process is terminated (block 822). If the relationship is not true, then the local addresses in the L2 level of cache for all entries in the WCD is set to null (block 826), and the value for the count for promotion to the L1 level of the cache structure is set to null for all entries in the WCD (block 828). The storage is added to the table of free storage on the cache structure (block 830), and then the process may proceed to a determination of whether the requested resource will fit in the L2 level of cache (block 804).

In FIG. 9, a process is depicted for handling resource requests for resources that have an entry in the WCD table but are not stored in the L1 or L2 levels of cache, and the resources are not eligible for promotion to level L2 of the cache structure as of the resource request under consideration. This situation occurs when, for example, the value of the h2 variable for this resource is less than the value of the H2 variable at the time of the most recent request for the resource (block 314). The request for the resource is passed to the originating server (block 900), and a determination is made whether the originating server responds (block 902). If it is determined that there is no response from the originating server, it is concluded that the resource has not been found (block 904) and the process is terminated with no further change to the WCD or the cache structure (block 906). If there is a response from the originating server in response to the request (block 902), the value of the variable holding the count for promotion of the requested resource to the L2 level of cache is incremented (block 908). The value of the variable indicating the time of the second most recent hit is set equal to the most recent hit (block 910), and the value for the variable indicating the most recent hit is set to the current time (block 912), and the process is terminated (block 914).

Although the cache structure and management algorithm of the invention has been described in the context of two levels of cache, it should be realized that the underlying concept may be extended to additional levels of cache.

As an option, one or more snapshots of the L1 level of cache may be created, which could be useful particularly if the profile of the content or resources being stored on the cache structure follows patterns, and the snapshot could be loaded to correspond to the patterns being observed in the contents of the cache. For example, resources being stored in the levels of cache in the afternoon period of the day might tend to be skewed relatively heavily toward business web sites, while in the evening period of the day the resources stored might be skewed heavily toward sports web sites, or there may be a skewing toward the resources on business sites on weekdays while weekend traffic tends to skew towards sports sites. When such general predictability is present, the administrator of the cache system, or an automatic profiler, has the option to force the content of the L1 level of the cache structure to an older or previous state by simply loading a new L1 table based upon one of the previous snapshots of the contents of the cache structure and then swapping in any data from the L2 level of the cache structure to the L1 level that may be accounted for in the snapshot.

As a further option in the operation of the cache system, the administrator or autoprofiler could level set the cache system by forcing the values recorded for the t1 variable (the time of the base hit) of all entries in the L1 level of cache to the same time, clear the L2 and L3 levels of the cache structure, and set the values of the h1 (count for L1 promotion) and h2 (count for L2 promotion) variables to a common level (for example, to the value of the H1 (minimum number of hits for L1 consideration) or H2 (minimum number of hits for L1 consideration) variables.

In highly preferred implementations of the invention, the data of the resources is held at all levels of cache on the cache structure so that as a resource on a given; level of the cache structure falls from, or advances to, another level of the cache structure, no transfer of data is required to accomplished that movement between the levels of cache, which helps minimize the amount of thrashing that may occur in the cache structure as resources are promoted and demoted. This optional also permits parallel access to the data of a resource at multiple levels of the cache simultaneously.

In another optional implementation of the cache system of the invention, which facilitates the creation of a relatively flat or single level cache, rather than promoting (or demoting) resources among multiple levels of the cache structure, the count of the number of hits may be used to determine if additional copies of the date of a resource should be added to the single level of cache to facilitate quicker access to the data of the resource, and similarly copies of the date could be removed from the level of cache if the number of hits for a particular resource does not justify the number of copies relative to other resources. This variation would be particularly useful if the cache was in a distributed storage environment (such as distributed over a number of networks of a grid), as it would allow multiple users or requestors to access the data of the same resource at distinct locations in a simultaneous manner.

In another aspect of the invention, a cache system is provided for a system or network that dynamically adjusts to better match the currently existing conditions on the network or computing grid. In general, the cache system monitors factors or conditions on the computing grid. These factors may include the current sustained level of bandwidth between the various levels of the memory hierarchy, and the amount of memory that is assigned to caching purposes at various levels of the cache. Based on the observed readings of these factors, cache levels are expanded or contracted on an ongoing, dynamic basis, and the profile of the cache may be modified, such as, for example, by increasing or decreasing associatively or pre fetch. These dynamic changes in the cache results in an overall cache architecture that changes or morphs itself to best match or suit the current conditions on the computing grid.

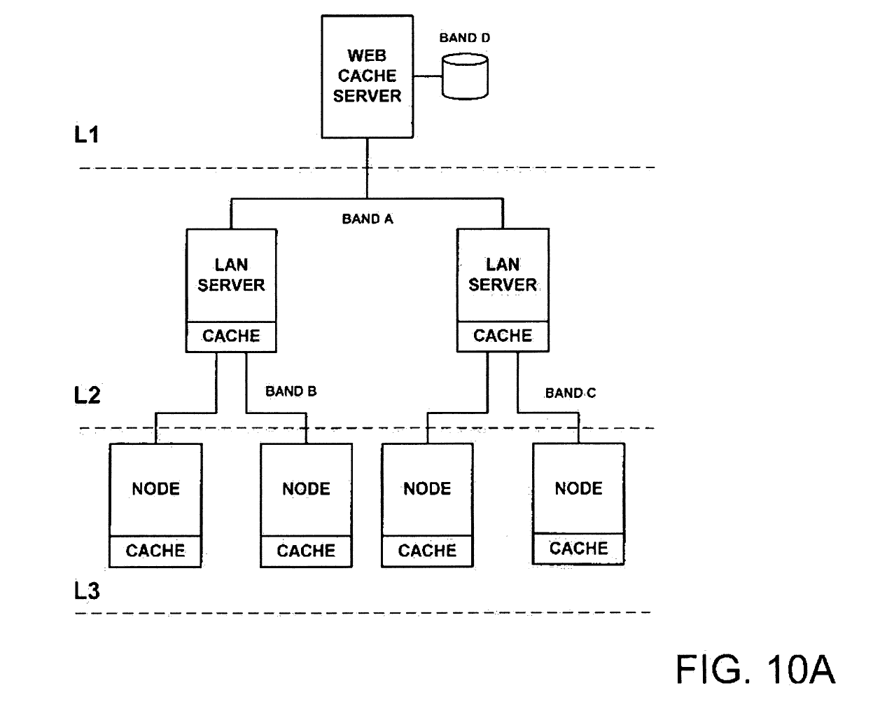

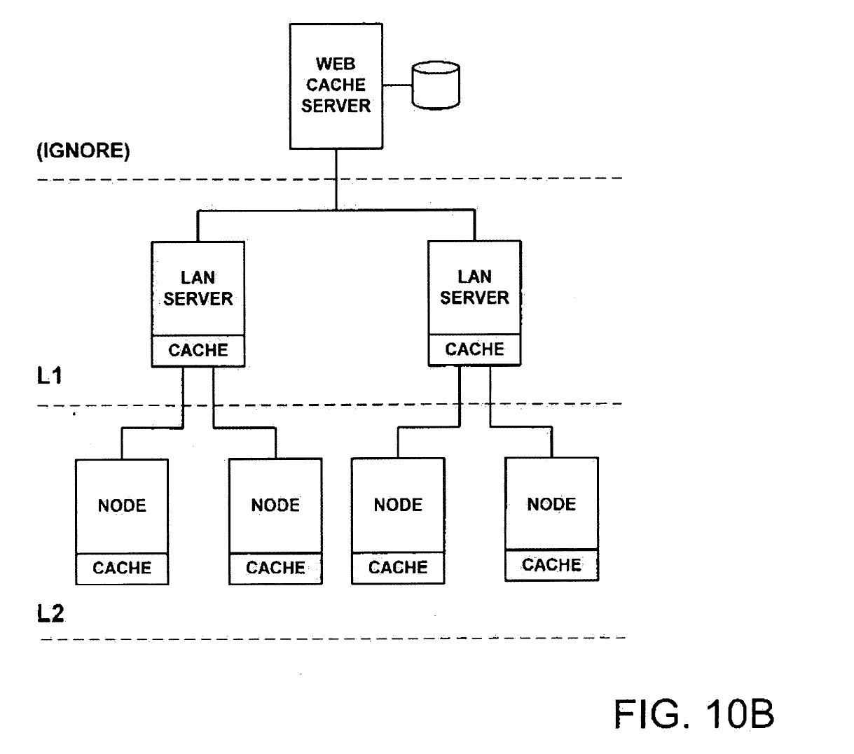

An example of the dynamic changing or adjustment of the cache architecture is depicted in FIGS. 10A and 10B. In the example, during a first state or mode of operation of the cache system depicted in FIG. 10A, the system recognizes that, due to changes in operating factors such as, for example, a reduction in the amount of storage made available for the purposes of the cache, or for example, a reduction in the bandwidth between the levels of the cache, bands “A” and “D” are performing at essentially the same level. This recognition may result from the data held in the L1 level of cache being duplicated in the L2 level of the cache, and from the recognition that as a result of the current conditions, the data being held in the L2 level of cache is largely redundant to that data held in the L1 level of cache. The system concludes that the overall performance of the cache can be improved by combining the data of the L1 level of cache and the L2 level of cache into a larger L1 level of cache. This action results is the second state of the cache, which is shown in FIG. 10B. As the L2 level of cache holds the same data as the L1 level of cache, the transition to the second state removes the redundancy that existed between the L1 level and the L2 level of cache in the first state shown in FIG. 10B.

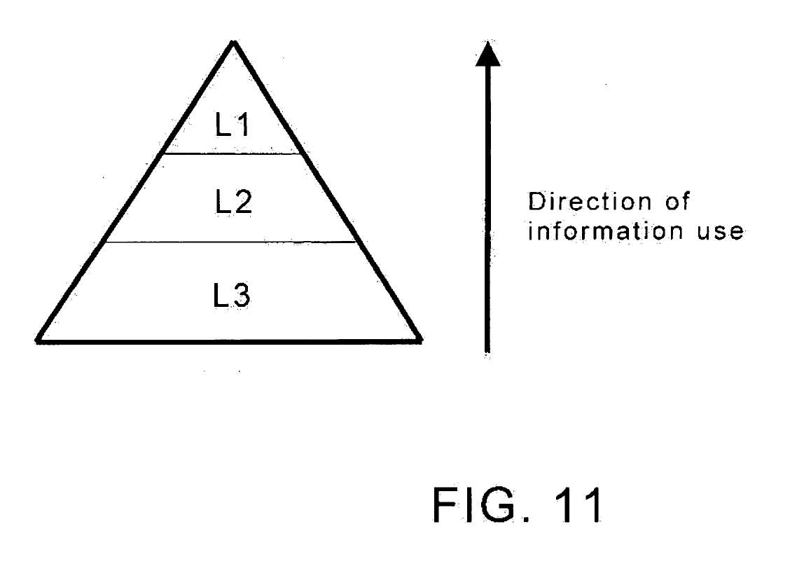

In another aspect of the grid cache system of the invention, it is helpful to think of the cache system as a plurality of triangles representing the cache available to each user of the system, with the narrowest portion of the triangle being positioned toward the user of the cache and toward the direction of information flow to the user, and the broadest portion of the triangle being oriented away from the user of the cache. As diagrammatically represented in FIG. 11, a portion or layer of cache at the top of the triangle, and closest to the user, is considered to be the L1 level of cache, which tends to include a collection of the storage with the relatively fastest speed, relatively smallest size, and relatively closest physical proximity to the user of the cache. The next broader portion of the triangle representing the cache available to the user is considered to be the L2 level of cache, which tends to include a collection of the storage with relatively slower speed relative to the storage in the L1 cache, relatively larger size than the storage in the L1 level of cache, and relatively physically farther from the user. In the next broader portion of the triangle representation of the cache, considered to be the L3 level of the cache available to the user, the storage with the relatively slowest speed, relatively largest size, and relatively largest physical separation from the user is located. It will be understood that the trends set forth here can be extended to additional levels of cache. Due to the manner in which these factors may vary from user to user, storage that is considered to be L1 for one user of the cache system may be L3 for another user, and thus a unit of storage on the grid is not at the same level of cache for all users of the cache system. Further, as the availability of units of storage fluctuate over time, the conceptual triangle representing the cache available to a particular user of the system will change and reorient itself, as if drifting in the “wind” of the flow of data across the grid. The size and orientation of these conceptual triangles may change freely as the needs across the grid cache change, however it is contemplated that it may be desirable for an operator or administrator of the grid cache to force the cache system to operate in a specific manner under a number of scenarios regarding the usage or the users. This forced mode of grid storage usage may be employed to take advantage of known cache usage models based upon observed trends of usage.

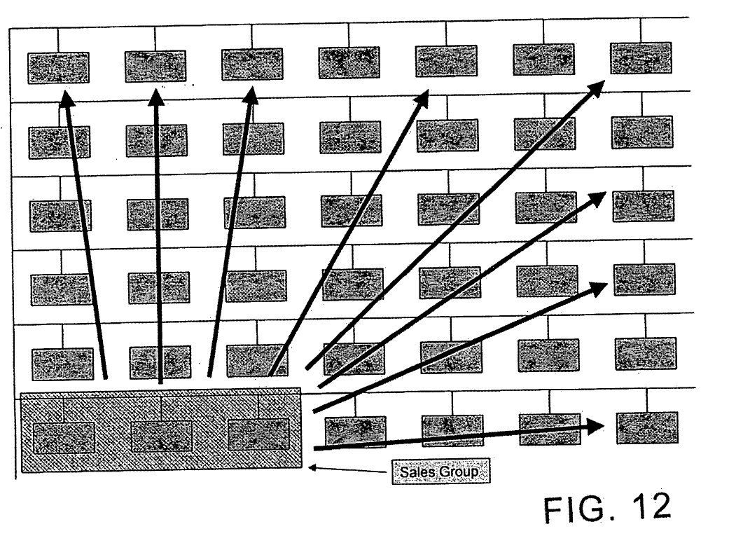

For example, as shown in FIG. 12, the operation of the grid cache may be set or forced so that the storage resources of a particular group or portion of an organization acts in a particular way. In this scenario, cached information for the grid is only allowed to flow away from the storage associated with the computers of the particular group. As a result, the storage associated with the group acts as a relatively high level of cache for the grid cache.

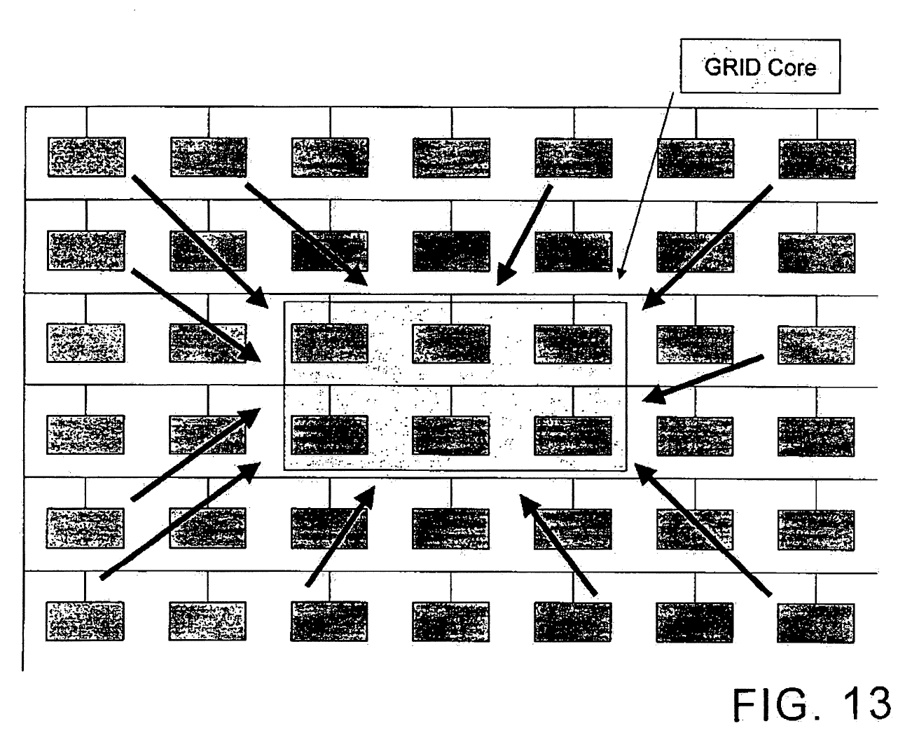

Another example, shown in FIG. 13, the operation of the grid cache may be set or forced so that cached information is only allowed to flow away from the peripheral portions of the grid system into a core portion of the storage resources on the overall grid system. The storage associated with the core portion of the grid system thus becomes a relatively low level of cache.

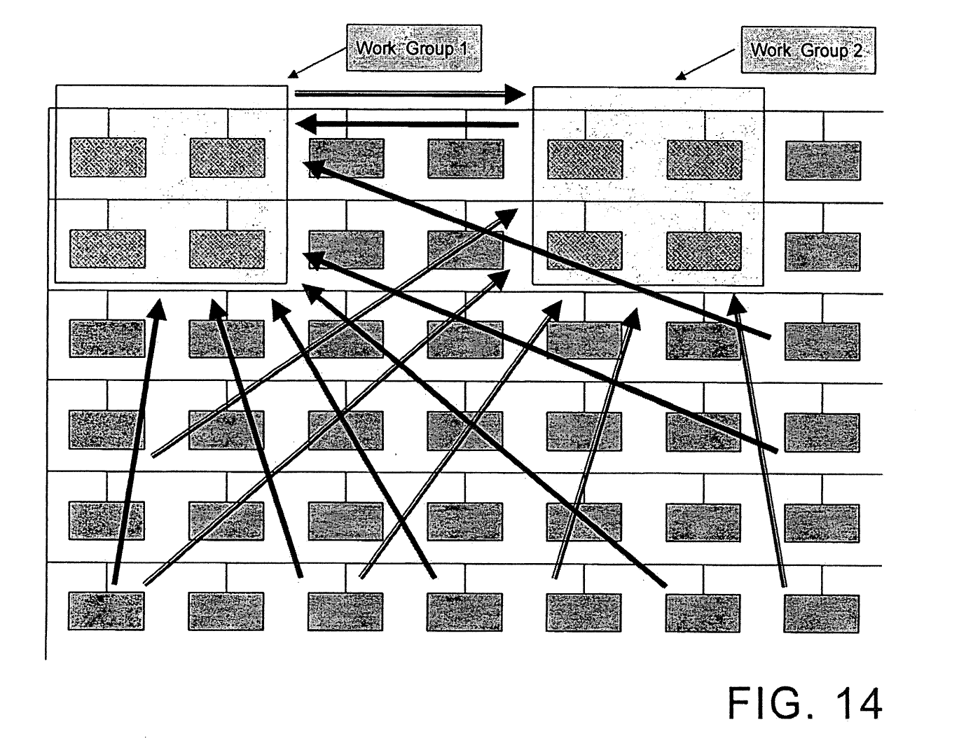

In yet another illustration of the concept, shown in FIG. 14, the operation of the grid cache may be set or forced so that cached information is only allowed to flow toward two portions or sections of the grid system. In this illustration, the portions of the grid system represent two work groups of a company. In this scenario, the information flow to the storage resources of the work groups makes these storage resources relatively low level cache with respect to the rest of the grid system.

As noted previously, the normal or typical operation of the grid cache system does not restrict the flow of information between cache users and storage resources on the grid system. Thus, each user of the grid cache system may function as relatively lower level cache for its own operations and may function as relatively higher cache for other users of the grid cache system.

The invention has been described in terms of various embodiments. It will be understood by those skilled in the art that various changes and modifications may be made to the embodiments without departing from the intent or scope of the invention. It is not intended that the invention be limited in any way to the embodiments shown and described herein and it is intended that the invention be limited only by the claims appended hereto.

1. A method of managing a cache, comprising:
receiving a request for a resource;
determining if a copy of the resource is stored in the cache, the cache including at least a first level of cache and a second level of cache;
counting a number of times that the requested resource, having a copy stored in the cache, has been requested; and
promoting the copy of the requested resource in the cache based upon a count of the number of times that the requested resource has been requested.

2. The method of claim 1 wherein the step of promoting the copy of the resource includes promoting the copy of the resource to the first level of cache if a first count of the number of requests for the requested resource exceeds a first predetermined number of requests, and promoting the copy of the resource from the second level of cache to the first level of cache if a second count of the number of requests for the requested resource exceeds a second predetermined number of requests.

3. The method of claim 1 wherein the resource request identifies the resource by a uniform resource locator (URL) indicating the original location of the resource on a network.

4. The method of claim 1 additionally comprising establishing a table with an entry for each copy of a resource stored in the cache.

5. The method of claim 1 wherein the step of determining includes determining if a copy of the requested resource is in the first level of cache, the second level of cache, or elsewhere in the cache but not on the first level of the cache or the second level of cache.

6. The method of claim 1 wherein the step of counting the number of times includes maintaining a first count, for each copy of a resource in the first level of the cache, of the number of times that a copy of the resource has been requested, and including maintaining a second count, for each copy of a resource in the second level of the cache, of the number of times that a copy of the resource has been requested.

7. The method of claim 1 wherein the step of counting the number of times includes incrementing a first count for a copy of a resource stored in the first level of the cache when a request is received for the resource, and includes incrementing the second count for a copy of a resource stored in the second level of the cache when a request is received for the resource.

8. The method of claim 1 additionally comprising the step of retaining a substantial duplicate copy of a copy of a resource, stored in the first level of cache, in the second level of the cache.
